(19) United States
(12) Patent Application Publication
(10) Pub. No.: US 2015/0117396 A1
(43) Pub. Date: Apr. 30, 2015

(54) DATA TRANSMISSION METHOD, BASE STATION, AND USER EQUIPMENT

(71) Applicant: Huawei Device Co., LTD., Shenzhen (CN)

(72) Inventors: Jian WANG, Beijing (CN); Lei GUAN, Beijing (CN)

(21) Appl. No.: 14/584,531

(22) Filed: Dec. 29, 2014

Related U.S. Application Data
(63) Continuation of application No. PCT/CN2013/073005, filed on Mar. 21, 2013.

(51) Int. Cl. H04W 72/04

(52) U.S. Cl. CPC H04W 72/042
USPC 370/330

(57) ABSTRACT

Embodiments of the present invention provide a data transmission method, a base station, and a user equipment. The base station selects a TBS corresponding to a modulation and coding scheme level and corresponding to the number of first physical resource block pairs or the number of second physical resource block pairs, where the number of the second physical resource block pairs is a product of the number of the first physical resource block pairs and a set conversion factor.

### CROSS REFERENCE AND RELATED APPLICATIONS

This application is a continuation of International Application No. PCT/CN2013/073005, filed on Mar. 21, 2013, which is incorporated herein by reference in its entirety.

### TECHNICAL FIELD

Embodiments of the present invention relate to the field of communications technologies, and in particular, to a data transmission method, a base station, and a user equipment.

### BACKGROUND

In systems of Long Term Evolution Release 8 (Long Term Evolution Release.8 REL.8, LTE REL.8 for short) to LTE REL.11, a state of a channel from a base station to a user equipment (User Equipment, UE for short) determines throughput from the base station to the UE. In a good channel state, the base station can transmit data to the UE by adopting a high modulation and coding scheme (Modulation and Coding Scheme, MCS for short) level, and system throughput is also relatively high. In a poor channel state, in order to control a bit error rate during a data transmission process, the base station can transmit data to the UE by adopting a low MCS level, and the base station determines, according to a channel state fed back by the UE, a coding rate and an MCS level adopted to transmit data to the UE on the channel. In order to achieve a purpose of transmitting the data to the UE at this coding rate, the base station needs to determine a transport block size that delivered service data needs to occupy. When determining the transport block size, the base station usually determines, in a transport block size table (Transport block size table, TBS table for short) according to the determined MCS level and a frequency resource scheduled by the system, the transport block size for bearing the service data delivered by the base station to the UE.

In the prior art, for LTEREL.12, the base station transmits data to the UE by adopting a transport block determined according to an existing TBS table. However, a system overhead of an LTE REL.12 system becomes smaller compared with system overheads of systems of LTE REL.8 to LTE REL.11, which results in a decrease in an actual effective coding rate during a transmission process, thereby affecting throughput of the LTE REL.12 system.

### SUMMARY

Embodiments of the present invention aims at providing a data transmission method, a base station, and a user equipment, to solve a problem that an effective coding rate is reduced and that system throughput is affected because a base station transmits data to a UE by using a transport block that is determined according to an existing TBS table.

According to a first aspect, an embodiment of the present invention provides a data transmission method, where the method includes:

determining, by a base station, a modulation and coding scheme level;

determining, by the base station, a time-frequency resource, and determining the number of first physical resource block pairs according to the time-frequency resource;

selecting, by the base station and from a transport block size table, a transport block size TBS corresponding to the modulation and coding scheme level and corresponding to the number of the first physical resource block pairs or the number of second physical resource block pairs, where the number of the second physical resource block pairs is a product of the number of the first physical resource block pairs and a set conversion factor;

sending, by the base station, service data to a user equipment by adopting the selected TBS; and

sending, by the base station, a system scheduling control signal to the user equipment, where the system scheduling control signal includes the modulation and coding scheme level and the time-frequency resource.

With reference to the first aspect, in a first possible implementation manner of the first aspect, the selecting, by the base station and from a transport block size table, a transport block size TBS corresponding to the modulation and coding scheme level and corresponding to the number of the first physical resource block pairs or the number of second physical resource block pairs, includes:

selecting, by the base station according to a system configuration parameter or a system overhead size, the TBS corresponding to the modulation and coding scheme level and corresponding to the number of the first physical resource block pairs, or, selecting the TBS corresponding to the modulation and coding scheme level and corresponding to the number of the second physical resource block pairs.

With reference to the first aspect or the first possible implementation manner of the first aspect, in a second possible implementation manner of the first aspect, the method further includes:

sending, by the base station, a higher-layer signaling message to the user equipment, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the first aspect or the first possible implementation manner of the first aspect, in a third possible implementation manner of the first aspect, the method further includes:

sending, by the base station, a downlink control message to the user equipment, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the first aspect, the first possible implementation manner of the first aspect, the second possible implementation manner of the first aspect, and the third possible implementation manner of the first aspect, in a fourth possible implementation manner of the first aspect, the transport block size table includes: a transport block size table of layer 1 data in a Long Term Evolution Release 8 LTE REL.8 system.

With reference to the first aspect, the first possible implementation manner of the first aspect, the second possible implementation manner of the first aspect, the third possible implementation manner of the first aspect, and the fourth possible implementation manner of the first aspect, in a fifth possible implementation manner of the first aspect, the set conversion factors include a first set conversion factor corresponding to a first modulation and coding scheme level and a second set conversion factor corresponding to a second modulation and coding scheme level in the transport block size table, and the first set conversion factor is different from the second set conversion factor.

With reference to the fifth possible implementation manner of the first aspect, in a sixth possible implementation manner of the first aspect, the first modulation and coding scheme level is a maximum modulation and coding scheme level in the transport block size table; and the second modulation and coding scheme level is a non-maximum modulation and coding scheme level in the transport block size table.

With reference to the fifth possible implementation manner of the first aspect or the sixth possible implementation manner of the first aspect, in a seventh possible implementation manner of the first aspect, the first set conversion factor is 1.1; and the second set conversion factor is 1.3.

With reference to the first aspect and any one possible implementation manner of the first possible implementation manner of the first aspect, the second possible implementation manner of the first aspect, the third possible implementation manner of the first aspect, the fourth possible implementation manner of the first aspect, the fifth possible implementation manner of the first aspect, the sixth possible implementation manner of the first aspect, and the seventh possible implementation manner of the first aspect, in an eighth possible implementation manner of the first aspect, if the number of the second physical resource block pairs is larger than the maximum number of physical resource block pairs of the transport block size table, the TBS corresponding to the modulation and coding scheme level and corresponding to the number of the second physical resource block pairs is a TBS corresponding to the modulation and coding scheme level and corresponding to the maximum number of the physical resource block pairs.

According to a second aspect, an embodiment of the present invention provides a data transmission method, where the method includes:

receiving, by a user equipment, a system scheduling control signal sent by a base station, where the system scheduling control signal includes a modulation and coding scheme level and a time-frequency resource;

selecting, by the user equipment and from a transport block size table, a transport block size TBS corresponding to the modulation and coding scheme level and corresponding to the number of the first physical resource block pairs or corresponding to the number of second physical resource block pairs, where the number of the second physical resource block pairs is a product of the number of the first physical resource block pairs and a set conversion factor; and

receiving, by the user equipment, service data from the base station by adopting the selected TBS.

With reference to the second aspect, in a first possible implementation manner of the second aspect, the selecting, by the user equipment and from a transport block size table, a transport block size TBS corresponding to the modulation and coding scheme level and corresponding to the number of the first physical resource block pairs or corresponding to the number of second physical resource block pairs, includes:

selecting, by the user equipment according to a system configuration parameter or a system overhead size, the TBS corresponding to the modulation and coding scheme level and corresponding to the number of the first physical resource block pairs, or, selecting the TBS corresponding to the modulation and coding scheme level and corresponding to the number of the second physical resource block pairs.

With reference to the second aspect or the first possible implementation manner of the second aspect, in a second possible implementation manner of the second aspect, the method further includes:

receiving, by the user equipment, a higher-layer signaling message sent by the base station, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the second aspect or the first possible implementation manner of the second aspect, in a third possible implementation manner of the second aspect, the method further includes:

receiving, by the user equipment, a downlink control message sent by the base station, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the second aspect, the first possible implementation manner of the second aspect, the second possible implementation manner of the second aspect, and the third possible implementation manner of the second aspect, in a fourth possible implementation manner of the second aspect, the transport block size table includes: a transport block size table of layer 1 data in a Long Term Evolution Release 8 LTE REL.8 system.

With reference to the second aspect, the first possible implementation manner of the second aspect, the second possible implementation manner of the second aspect, the third possible implementation manner of the second aspect, and the fourth possible implementation manner of the second aspect, in a fifth possible implementation manner of the second aspect, the set conversion factors include a first set conversion factor corresponding to a first modulation and coding scheme level and a second set conversion factor corresponding to a second modulation and coding scheme level in the transport block size table, and the first set conversion factor is different from the second set conversion factor.

With reference to the fifth possible implementation manner of the second aspect, in a sixth possible implementation manner of the second aspect, the first modulation and coding scheme level is a maximum modulation and coding scheme level in the transport block size table; and the second modulation and coding scheme level is a non-maximum modulation and coding scheme level in the transport block size table.

With reference to the fifth possible implementation manner of the second aspect or the sixth possible implementation manner of the second aspect, in a seventh possible implementation manner of the second aspect, the first set conversion factor is 1.1; and the second set conversion factor is 1.3.

With reference to the second aspect and any one possible implementation manner of the first possible implementation manner of the second aspect, the second possible implementation manner of the second aspect, the third possible implementation manner of the second aspect, the fourth possible implementation manner of the second aspect, the fifth possible implementation manner of the second aspect, the sixth possible implementation manner of the second aspect, and the seventh possible implementation manner of the second aspect, in an eighth possible implementation manner of the second aspect, if the number of the second physical resource block pairs is larger than the maximum number of physical resource block pairs of the transport block size table, the TBS corresponding to the modulation and coding scheme level and corresponding to the number of the second physical resource block pairs is a TBS corresponding to the modulation and coding scheme level and corresponding to the maximum number of the physical resource block pairs.

According to a third aspect, an embodiment of the present invention provides a base station, where the base station includes:

a processor, configured to determine a modulation and coding scheme level; determine a time-frequency resource, and determine the number of first physical resource block pairs according to the time-frequency resource; and select, from a transport block size table, a transport block size TBS corresponding to the modulation and coding scheme level and corresponding to the number of the first physical resource block pairs or the number of second physical resource block pairs, where the number of the second physical resource block pairs is a product of the number of the first physical resource block pairs and a set conversion factor; and

a transmitter, configured to send service data to a user equipment by adopting the selected TBS; and send a system scheduling control signal to the user equipment, where the system scheduling control signal includes the modulation and coding scheme level and the time-frequency resource.

With reference to the third aspect, in a first possible implementation manner of the third aspect, the processor is further configured to select, according to a system configuration parameter or a system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

With reference to the third aspect or the first possible implementation manner of the third aspect, in a second possible implementation manner of the third aspect, the transmitter is further configured to send a higher-layer signaling message to the user equipment, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the third aspect or the first possible implementation manner of the third aspect, in a third possible implementation manner of the third aspect, the transmitter is further configured to send a downlink control message to the user equipment, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the third aspect, the first possible implementation manner of the third aspect, the second possible implementation manner of the third aspect, and the third possible implementation manner of the third aspect, in a fourth possible implementation manner of the third aspect, the transport block size table includes: a transport block size table of layer 1 data in a Long Term Evolution Release 8 LTE REL.8 system.

With reference to the third aspect, the first possible implementation manner of the third aspect, the second possible implementation manner of the third aspect, the third possible implementation manner of the third aspect, and the fourth possible implementation manner of the third aspect, in a fifth possible implementation manner of the third aspect, the set conversion factors include a first set conversion factor corresponding to a first modulation and coding scheme level and a second set conversion factor corresponding to a second modulation and coding scheme level in the transport block size table, and the first set conversion factor is different from the second set conversion factor.

With reference to the fifth possible implementation manner of the third aspect, in a sixth possible implementation manner of the third aspect, the first modulation and coding scheme level is a maximum modulation and coding scheme level in the transport block size table; and the second modulation and coding scheme level is a non-maximum modulation and coding scheme level in the transport block size table.

With reference to the fifth possible implementation manner of the third aspect or the sixth possible implementation manner of the third aspect, in a seventh possible implementation manner of the third aspect, the first set conversion factor is 1.1; and the second set conversion factor is 1.3.

With reference to the third aspect and any one possible implementation manner of the first possible implementation manner of the third aspect, the second possible implementation manner of the third aspect, the third possible implementation manner of the third aspect, the fourth possible implementation manner of the third aspect, the fifth possible implementation manner of the third aspect, the sixth possible implementation manner of the third aspect, and the seventh possible implementation manner of the third aspect, in an eighth possible implementation manner of the third aspect, the processor is further configured to, when the number of the second physical resource block pairs is larger than the maximum number of physical resource block pairs of the transport block size table, determine that the TBS corresponding to the modulation and coding scheme level and corresponding to the number of the second physical resource block pairs is a TBS corresponding to the modulation and coding scheme level and corresponding to the maximum number of the physical resource block pairs.

According to a fourth aspect, an embodiment of the present invention provides a user equipment, where the user equipment includes:

a receiver, configured to receive a system scheduling control signal sent by a base station, where the system scheduling control signal includes a modulation and coding scheme level and a time-frequency resource; and

a processor, configured to select, from a transport block size table, a transport block size TBS corresponding to the modulation and coding scheme level and corresponding to the number of the first physical resource block pairs or corresponding to the number of second physical resource block pairs, where the number of the second physical resource block pairs is a product of the number of the first physical resource block pairs and a set conversion factor; and receive service data from the base station by adopting the selected TBS.

With reference to the fourth aspect, in a first possible implementation manner of the fourth aspect, the processor is further configured to select, according to a system configuration parameter or a system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

With reference to the fourth aspect or the first possible implementation manner of the fourth aspect, in a second possible implementation manner of the fourth aspect, the receiver is further configured to receive a higher-layer signaling message sent by the base station, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the fourth aspect or the first possible implementation manner of the fourth aspect, in a third possible implementation manner of the fourth aspect, the receiver is further configured to receive a downlink control message sent by the base station, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

With reference to the fourth aspect, the first possible implementation manner of the fourth aspect, the second possible implementation manner of the fourth aspect, and the third possible implementation manner of the fourth aspect, in a fourth possible implementation manner of the fourth aspect, the transport block size table includes: a transport block size table of layer 1 data in a Long Term Evolution Release 8 LTE REL.8 system.

With reference to the fourth aspect, the first possible implementation manner of the fourth aspect, the second possible implementation manner of the fourth aspect, the third possible implementation manner of the fourth aspect, and the fourth possible implementation manner of the fourth aspect, in a fifth possible implementation manner of the fourth aspect, the set conversion factors include a first set conversion factor corresponding to a first modulation and coding scheme level and a second set conversion factor corresponding to a second modulation and coding scheme level in the transport block size table, and the first set conversion factor is different from the second set conversion factor.

With reference to the fifth possible implementation manner of the fourth aspect, in a sixth possible implementation manner of the fourth aspect, the first modulation and coding scheme level is a maximum modulation and coding scheme level in the transport block size table; and the second modulation and coding scheme level is a non-maximum modulation and coding scheme level in the transport block size table.

With reference to the fifth possible implementation manner of the fourth aspect or the sixth possible implementation manner of the fourth aspect, in a seventh possible implementation manner of the fourth aspect, the first set conversion factor is 1.1; and the second set conversion factor is 1.3.

With reference to the fourth aspect and any one possible implementation manner of the first possible implementation manner of the fourth aspect, the second possible implementation manner of the fourth aspect, the third possible implementation manner of the fourth aspect, the fourth possible implementation manner of the fourth aspect, the fifth possible implementation manner of the fourth aspect, the sixth possible implementation manner of the fourth aspect, and the seventh possible implementation manner of the fourth aspect, in an eighth possible implementation manner of the fourth aspect, the processor is further configured to, when the number of the second physical resource block pairs is larger than the maximum number of physical resource block pairs of the transport block size table, determine that the TBS corresponding to the modulation and coding scheme level and corresponding to the number of the second physical resource block pairs is a TBS corresponding to the modulation and coding scheme level and corresponding to the number maximum of the physical resource block pairs.

In the data transmission method, the base station, and the user equipment of the embodiments, the base station determines a modulation and coding scheme level and a time-frequency resource, and determines the number of first physical resource block pairs according to the time-frequency resource; selects, from a transport block size table, a transport block size TBS corresponding to the modulation and coding scheme level and corresponding to the number of the first physical resource block pairs or the number of second physical resource block pairs, where the number of the second physical resource block pairs is a product of the number of the first physical resource block pairs and a set conversion factor; sends service data to the user equipment by adopting the selected TBS; and sends a system scheduling control signal to the user equipment, where the system scheduling control signal includes the modulation and coding scheme level and the time-frequency resource. In this way, a selection of the TBS by the base station is implemented, so that an expected coding rate can be achieved when the base station transmits service data to the UE according to the selected TBS, and system throughput is improved.

### BRIEF DESCRIPTION OF DRAWINGS

To describe the technical solutions in the embodiments of the present invention or in the prior art more clearly, the following briefly introduces accompanying drawings required for describing the embodiments. Apparently, the accompanying drawings in the following description show some embodiments of the present invention, and persons of ordinary skill in the art may still derive other drawings according to these accompanying drawings without creative efforts.

FIG. 1 is a method flowchart of a first embodiment of a data transmission method according to the present invention;

FIG. 2 is a method flowchart of a second embodiment of a data transmission method according to the present invention;

FIG. 3 is a schematic structural diagram of a first embodiment of a base station according to the present invention; and

FIG. 4 is a schematic structural diagram of a first embodiment of a user equipment according to of the present invention.

### DESCRIPTION OF EMBODIMENTS

To make the objectives, technical solutions, and advantages of the present invention clearer, the following clearly describes the technical solutions in the present invention with reference to the accompanying drawings in the present invention. Apparently, the embodiments to be described are a part rather than all of the embodiments of the present invention. All other embodiments obtained by persons of ordinary skill in the art based on the embodiments of the present invention without creative efforts shall fall within the protection scope of the present invention.

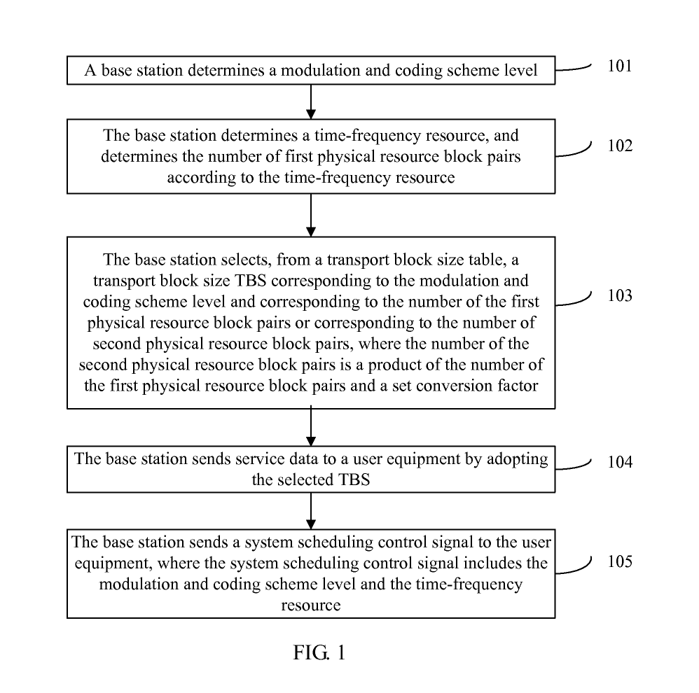

FIG. 1 is a method flowchart of a first embodiment of a data transmission method of the present invention. As shown in FIG. 1, the data transmission method of this embodiment includes:

101: A base station determines a modulation and coding scheme level.

When sending service data to a user equipment (English full name: User Equipment, UE for short), the base station needs to determine the modulation and coding scheme level (English full name: Modulation and Coding Scheme Level, MCS Level for short), so that the base station performs coding, according to the determined MCS level, on the service data to be transmitted. Specifically, the base station may determine the MCS level according to a channel state reported by the UE. When a communication channel between the base station and the UE is in a good state, the base station may determine a high MCS level as the modulation and coding scheme level to perform coding on the service data to be transmitted; and when the communication channel between the base station and the UE is in a poor state, the base station may determine a low MCS level as the modulation and coding scheme level to perform coding on the service data to be transmitted.

102: The base station determines a time-frequency resource, and determines the number of first physical resource block pairs according to the time-frequency resource.

A system may schedule the time-frequency resource for data transmission according to current time-frequency resource availability. The base station determines, according to the determined time-frequency resource, the number of physical resource block pairs (Physical Resource Block Pair, PRB pair for short) for transmitting the service data by the base station to the UE. For example, the base station determines that the number of the PRB pairs is 11, and then the base station bears the service data on the 11 PRB pairs.

103: The base station selects, from a transport block size table, a transport block size TBS corresponding to the modulation and coding scheme level and corresponding to the number of the first physical resource block pairs or the number of second physical resource block pairs, where the number of the second physical resource block pairs is a product of the number of the first physical resource block pairs and a set conversion factor.

Specifically, the base station may firstly determine, according to the determined MCS level and in a transport block size index table (Modulation and TBS index table for PDSCH), a modulation order index value and a TBS index value corresponding to the MCS level; and then select, from the transport block size table, the transport block size (Transport block size, TBS for short) corresponding to the MCS level and corresponding to the number of the first physical resource block pairs determined in step 102, where a coding rate corresponding to the TBS can match the MCS level determined by the base station.

Alternatively, the base station may firstly determine, according to the determined MCS level, in a transport block size index table (Modulation and TBS index table for PDSCH), a modulation order index value and a TBS index value corresponding to the MCS level; and then select, from the transport block size table, the TBS corresponding to the MCS level and corresponding to the number of the second physical resource block pairs, where a coding rate corresponding to the TBS can match the MCS level determined by the base station.

The number of the first physical resource block pairs is the number of the physical resource block pairs determined by the base station according to system scheduling, and the number of the second physical resource block pairs is a product of the number of the first physical resource block pairs and the set conversion factor.

104: The base station sends the service data to the user equipment by adopting the selected TBS.

Specifically, the base station modulates the service data onto the TBS determined in step 103, and sends the modulated service data to the UE.

105: The base station sends a system scheduling control signal to the user equipment, where the system scheduling control signal includes the modulation and coding scheme level and the time-frequency resource.

Specifically, the base station sends the system scheduling control signal that includes the MCS level and the time-frequency resource determined by the base station to the UE, so that the UE can correctly receive, according to the MCS level and the time-frequency resource, the service data sent by the base station to the UE. The time-frequency resource is the number of the first physical resource block pairs or the number of the second physical resource block pairs. When the base station selects the TBS corresponding to the number of the second physical resource block pairs in step 103, the time-frequency resource included in the system scheduling control signal is the number of the second physical resource block pairs. When the base station selects the TBS corresponding to the number of the first physical resource block pairs in step 103, the time-frequency resource included in the system scheduling control signal is the number of the first physical resource block pairs.

In the data transmission method of this embodiment, the base station determines a modulation and coding scheme level and a time-frequency resource, and determines the number of first physical resource block pairs according to the time-frequency resource; selects, from a transport block size table, a transport block size TBS corresponding to the modulation and coding scheme level and corresponding to the number of the first physical resource block pairs or the number of second physical resource block pairs, where the number of the second physical resource block pairs is a product of the number of the first physical resource block pairs and a set conversion factor; sends service data to a user equipment by adopting the selected TBS; and sends a system scheduling control signal to the user equipment, where the system scheduling control signal includes a modulation and coding scheme level and a time-frequency resource. In this way, a selection of the TBS by the base station is implemented, so that an expected coding rate can be achieved when the base station transmits the service data to the UE according to the selected TBS, and system throughput is improved.

Further, based on the foregoing embodiment, that the base station selects, from a transport block size table, a transport block size TBS corresponding to the modulation and coding scheme level and corresponding to the number of the first physical resource block pairs or the number of second physical resource block pairs, may specifically include that: the base station selects, according to a system configuration parameter or a system overhead size, the TBS corresponding to the modulation and coding scheme level and corresponding to the number of the first physical resource block pairs, or, selects the TBS corresponding to the modulation and coding scheme level and corresponding to the number of the second physical resource block pairs.

Specifically, the base station may select, according to the system configuration parameter, the TBS corresponding to the modulation and coding scheme level and corresponding to the number of the first physical resource block pairs, or, select the TBS corresponding to the modulation and coding scheme level and corresponding to the number of the second physical resource block pairs.

For example, when the system configuration parameter indicates that control signaling contains a physical downlink control channel, the base station selects the TBS corresponding to the modulation and coding scheme level and corresponding to the number of the first physical resource block pairs; and when the system configuration parameter indicates that the control signaling does not contain the physical downlink control channel, the base station selects the TBS corresponding to the modulation and coding scheme level and corresponding to the number of the second physical resource block pairs.

Alternatively, the base station may select, according to the system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

For example, when the system overhead size is 48 resource elements, the base station selects the TBS corresponding to the modulation and coding scheme level and corresponding to the number of the first physical resource block pairs; and when the system overhead is 12 resource elements, the base station selects the TBS corresponding to the modulation and coding scheme level and corresponding to the number of the second physical resource block pairs.

Further, based on the foregoing embodiment, the data transmission method of this embodiment may further include: sending, by the base station, a higher-layer signaling message to the user equipment, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

Specifically, the higher-layer signaling message sent by the base station to the UE may carry the instruction information of instructing the UE to select the TBS corresponding to the modulation and coding scheme level and corresponding to the number of the first physical resource block pairs, or, to select the TBS corresponding to the modulation and coding scheme level and corresponding to the number of the second physical resource block pairs, so that the higher-layer signaling is used to notify the UE of how to determine the TBS when receiving the service data.

Further, based on the foregoing embodiment, the data transmission method of this embodiment may further include: sending, by the base station, a downlink control message to the user equipment, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs, which may increase a switching speed of the base station among different selections.

Further, the transport block size table may include: a transport block size table of layer 1 data in a Long Term Evolution Release 8 LTE REL.8 system.

Specifically, the transport block size table of layer 1 data in the LTE REL.8 may be shown in Table 1.

TABLE 1
Transport block size table of layer 1 data in LTE REL.8

| | N_{PRB} | | | | | | | | | |
|---|---|---|---|---|---|---|---|---|---|---|
| I_{TBS} | 1 | 2 | 3 | 4 | 5 | 6 | 7 | 8 | 9 | 10 |
| 0 | 16 | 32 | 56 | 88 | 120 | 152 | 176 | 208 | 224 | 256 |
| 1 | 24 | 56 | 88 | 144 | 176 | 208 | 224 | 256 | 328 | 344 |
| 2 | 32 | 72 | 144 | 176 | 208 | 256 | 296 | 328 | 376 | 424 |
| 3 | 40 | 104 | 176 | 208 | 256 | 328 | 392 | 440 | 504 | 568 |
| 4 | 56 | 120 | 208 | 256 | 328 | 408 | 488 | 552 | 632 | 696 |
| 5 | 72 | 144 | 224 | 328 | 424 | 504 | 600 | 680 | 776 | 872 |
| 6 | 328 | 176 | 256 | 392 | 504 | 600 | 712 | 808 | 936 | 1032 |
| 7 | 104 | 224 | 328 | 472 | 584 | 712 | 840 | 968 | 1096 | 1224 |
| 8 | 120 | 256 | 392 | 536 | 680 | 808 | 968 | 1096 | 1256 | 1384 |
| 9 | 136 | 296 | 456 | 616 | 776 | 936 | 1096 | 1256 | 1416 | 1544 |
| 10 | 144 | 328 | 504 | 680 | 872 | 1032 | 1224 | 1384 | 1544 | 1736 |
| 11 | 176 | 376 | 584 | 776 | 1000 | 1192 | 1384 | 1608 | 1800 | 2024 |
| 12 | 208 | 440 | 680 | 904 | 1128 | 1352 | 1608 | 1800 | 2024 | 2280 |
| 13 | 224 | 488 | 744 | 1000 | 1256 | 1544 | 1800 | 2024 | 2280 | 2536 |
| 14 | 256 | 552 | 840 | 1128 | 1416 | 1736 | 1992 | 2280 | 2600 | 2856 |
| 15 | 280 | 600 | 904 | 1224 | 1544 | 1800 | 2152 | 2472 | 2728 | 3112 |
| 16 | 328 | 632 | 968 | 1288 | 1608 | 1928 | 2280 | 2600 | 2984 | 3240 |
| 17 | 336 | 696 | 1064 | 1416 | 1800 | 2152 | 2536 | 2856 | 3240 | 3624 |
| 18 | 376 | 776 | 1160 | 1544 | 1992 | 2344 | 2792 | 3112 | 3624 | 4008 |
| 19 | 408 | 840 | 1288 | 1736 | 2152 | 2600 | 2984 | 3496 | 3880 | 4264 |
| 20 | 440 | 904 | 1384 | 1864 | 2344 | 2792 | 3240 | 3752 | 4136 | 4584 |
| 21 | 488 | 1000 | 1480 | 1992 | 2472 | 2984 | 3496 | 4008 | 4584 | 4968 |
| 22 | 520 | 1064 | 1608 | 2152 | 2664 | 3240 | 3752 | 4264 | 4776 | 5352 |
| 23 | 552 | 1128 | 1736 | 2280 | 2856 | 3496 | 4008 | 4584 | 5160 | 5736 |
| 24 | 584 | 1192 | 1800 | 2408 | 2984 | 3624 | 4264 | 4968 | 5544 | 5992 |
| 25 | 616 | 1256 | 1864 | 2536 | 3112 | 3752 | 4392 | 5160 | 5736 | 6200 |
| 26 | 712 | 1480 | 2216 | 2984 | 3752 | 4392 | 5160 | 5992 | 6712 | 7480 |
| | N_{PRB} | | | | | | | | | |
| I_{TBS} | 11 | 12 | 13 | 14 | 15 | 16 | 17 | 18 | 19 | 20 |
| 0 | 288 | 328 | 344 | 376 | 392 | 424 | 456 | 488 | 504 | 536 |
| 1 | 376 | 424 | 456 | 488 | 520 | 568 | 600 | 632 | 680 | 712 |
| 2 | 472 | 520 | 568 | 616 | 648 | 696 | 744 | 776 | 840 | 872 |
| 3 | 616 | 680 | 744 | 808 | 872 | 904 | 968 | 1032 | 1096 | 1160 |
| 4 | 776 | 840 | 904 | 1000 | 1064 | 1128 | 1192 | 1288 | 1352 | 1416 |
| 5 | 968 | 1032 | 1128 | 1224 | 1320 | 1384 | 1480 | 1544 | 1672 | 1736 |
| 6 | 1128 | 1224 | 1352 | 1480 | 1544 | 1672 | 1736 | 1864 | 1992 | 2088 |
| 7 | 1320 | 1480 | 1608 | 1672 | 1800 | 1928 | 2088 | 2216 | 2344 | 2472 |
| 8 | 1544 | 1672 | 1800 | 1928 | 2088 | 2216 | 2344 | 2536 | 2664 | 2792 |
| 9 | 1736 | 1864 | 2024 | 2216 | 2344 | 2536 | 2664 | 2856 | 2984 | 3112 |
| 10 | 1928 | 2088 | 2280 | 2472 | 2664 | 2792 | 2984 | 3112 | 3368 | 3496 |
| 11 | 2216 | 2408 | 2600 | 2792 | 2984 | 3240 | 3496 | 3624 | 3880 | 4008 |
| 12 | 2472 | 2728 | 2984 | 3240 | 3368 | 3624 | 3880 | 4136 | 4392 | 4584 |
| 13 | 2856 | 3112 | 3368 | 3624 | 3880 | 4136 | 4392 | 4584 | 4968 | 5160 |
| 14 | 3112 | 3496 | 3752 | 4008 | 4264 | 4584 | 4968 | 5160 | 5544 | 5736 |
| 15 | 3368 | 3624 | 4008 | 4264 | 4584 | 4968 | 5160 | 5544 | 5736 | 6200 |
| 16 | 3624 | 3880 | 4264 | 4584 | 4968 | 5160 | 5544 | 5992 | 6200 | 6456 |
| 17 | 4008 | 4392 | 4776 | 5160 | 5352 | 5736 | 6200 | 6456 | 6712 | 7224 |
| 18 | 4392 | 4776 | 5160 | 5544 | 5992 | 6200 | 6712 | 7224 | 7480 | 7992 |
| 19 | 4776 | 5160 | 5544 | 5992 | 6456 | 6968 | 7224 | 7736 | 8248 | 8504 |
| 20 | 5160 | 5544 | 5992 | 6456 | 6968 | 7480 | 7992 | 8248 | 8760 | 9144 |
| 21 | 5544 | 5992 | 6456 | 6968 | 7480 | 7992 | 8504 | 9144 | 9528 | 9912 |
| 22 | 5992 | 6456 | 6968 | 7480 | 7992 | 8504 | 9144 | 9528 | 10296 | 10680 |
| 23 | 6200 | 6968 | 7480 | 7992 | 8504 | 9144 | 9912 | 10296 | 11064 | 11448 |
| 24 | 6712 | 7224 | 7992 | 8504 | 9144 | 9912 | 10296 | 11064 | 11448 | 12216 |
| 25 | 6968 | 7480 | 8248 | 8760 | 9528 | 10296 | 10680 | 11448 | 12216 | 12576 |
| 26 | 8248 | 8760 | 9528 | 10296 | 11064 | 11832 | 12576 | 13536 | 14112 | 14688 |
| | N_{PRB} | | | | | | | | | |
| I_{TBS} | 21 | 22 | 23 | 24 | 25 | 26 | 27 | 28 | 29 | 30 |
| 0 | 568 | 600 | 616 | 648 | 680 | 712 | 744 | 776 | 776 | 808 |
| 1 | 744 | 776 | 808 | 872 | 904 | 936 | 968 | 1000 | 1032 | 1064 |
| 2 | 936 | 968 | 1000 | 1064 | 1096 | 1160 | 1192 | 1256 | 1288 | 1320 |
| 3 | 1224 | 1256 | 1320 | 1384 | 1416 | 1480 | 1544 | 1608 | 1672 | 1736 |
| 4 | 1480 | 1544 | 1608 | 1736 | 1800 | 1864 | 1928 | 1992 | 2088 | 2152 |
| 5 | 1864 | 1928 | 2024 | 2088 | 2216 | 2280 | 2344 | 2472 | 2536 | 2664 |
| 6 | 2216 | 2280 | 2408 | 2472 | 2600 | 2728 | 2792 | 2984 | 2984 | 3112 |
| 7 | 2536 | 2664 | 2792 | 2984 | 3112 | 3240 | 3368 | 3368 | 3496 | 3624 |
| 8 | 2984 | 3112 | 3240 | 3368 | 3496 | 3624 | 3752 | 3880 | 4008 | 4264 |
| 9 | 3368 | 3496 | 3624 | 3752 | 4008 | 4136 | 4264 | 4392 | 4584 | 4776 |
| 10 | 3752 | 3880 | 4008 | 4264 | 4392 | 4584 | 4776 | 4968 | 5160 | 5352 |
| 11 | 4264 | 4392 | 4584 | 4776 | 4968 | 5352 | 5544 | 5736 | 5992 | 5992 |
| 12 | 4776 | 4968 | 5352 | 5544 | 5736 | 5992 | 6200 | 6456 | 6712 | 6712 |
| 13 | 5352 | 5736 | 5992 | 6200 | 6456 | 6712 | 6968 | 7224 | 7480 | 7736 |
| 14 | 5992 | 6200 | 6456 | 6968 | 7224 | 7480 | 7736 | 7992 | 8248 | 8504 |
| 15 | 6456 | 6712 | 6968 | 7224 | 7736 | 7992 | 8248 | 8504 | 8760 | 9144 |
| 16 | 6712 | 7224 | 7480 | 7736 | 7992 | 8504 | 8760 | 9144 | 9528 | 9912 |
| 17 | 7480 | 7992 | 8248 | 8760 | 9144 | 9528 | 9912 | 10296 | 10296 | 10680 |
| 18 | 8248 | 8760 | 9144 | 9528 | 9912 | 10296 | 10680 | 11064 | 11448 | 11832 |
| 19 | 9144 | 9528 | 9912 | 10296 | 10680 | 11064 | 11448 | 12216 | 12576 | 12960 |
| 20 | 9912 | 10296 | 10680 | 11064 | 11448 | 12216 | 12576 | 12960 | 13536 | 14112 |
| 21 | 10680 | 11064 | 11448 | 12216 | 12576 | 12960 | 13536 | 14112 | 14688 | 15264 |
| 22 | 11448 | 11832 | 12576 | 12960 | 13536 | 14112 | 14688 | 15264 | 15840 | 16416 |
| 23 | 12216 | 12576 | 12960 | 13536 | 14112 | 14688 | 15264 | 15840 | 16416 | 16992 |
| 24 | 12960 | 13536 | 14112 | 14688 | 15264 | 15840 | 16416 | 16992 | 17568 | 18336 |
| 25 | 13536 | 14112 | 14688 | 15264 | 15840 | 16416 | 16992 | 17568 | 18336 | 19080 |
| 26 | 15264 | 16416 | 16992 | 17568 | 18336 | 19080 | 19848 | 20616 | 21384 | 22152 |
| | N_{PRB} | | | | | | | | | |
| I_{TBS} | 31 | 32 | 33 | 34 | 35 | 36 | 37 | 38 | 39 | 40 |
| 0 | 840 | 872 | 904 | 936 | 968 | 1000 | 1032 | 1032 | 1064 | 1096 |
| 1 | 1128 | 1160 | 1192 | 1224 | 1256 | 1288 | 1352 | 1384 | 1416 | 1416 |
| 2 | 1384 | 1416 | 1480 | 1544 | 1544 | 1608 | 1672 | 1672 | 1736 | 1800 |
| 3 | 1800 | 1864 | 1928 | 1992 | 2024 | 2088 | 2152 | 2216 | 2280 | 2344 |
| 4 | 2216 | 2280 | 2344 | 2408 | 2472 | 2600 | 2664 | 2728 | 2792 | 2856 |
| 5 | 2728 | 2792 | 2856 | 2984 | 3112 | 3112 | 3240 | 3368 | 3496 | 3496 |
| 6 | 3240 | 3368 | 3496 | 3496 | 3624 | 3752 | 3880 | 4008 | 4136 | 4136 |
| 7 | 3752 | 3880 | 4008 | 4136 | 4264 | 4392 | 4584 | 4584 | 4776 | 4968 |
| 8 | 4392 | 4584 | 4584 | 4776 | 4968 | 4968 | 5160 | 5352 | 5544 | 5544 |
| 9 | 4968 | 5160 | 5160 | 5352 | 5544 | 5736 | 5736 | 5992 | 6200 | 6200 |
| 10 | 5544 | 5736 | 5736 | 5992 | 6200 | 6200 | 6456 | 6712 | 6712 | 6968 |
| 11 | 6200 | 6456 | 6712 | 6968 | 6968 | 7224 | 7480 | 7736 | 7736 | 7992 |
| 12 | 6968 | 7224 | 7480 | 7736 | 7992 | 8248 | 8504 | 8760 | 8760 | 9144 |
| 13 | 7992 | 8248 | 8504 | 8760 | 9144 | 9144 | 9528 | 9912 | 9912 | 10296 |
| 14 | 8760 | 9144 | 9528 | 9912 | 9912 | 10296 | 10680 | 11064 | 11064 | 11448 |
| 15 | 9528 | 9912 | 10296 | 10296 | 10680 | 11064 | 11448 | 11832 | 11832 | 12216 |
| 16 | 9912 | 10296 | 10680 | 11064 | 11448 | 11832 | 12216 | 12216 | 12576 | 12960 |
| 17 | 11064 | 11448 | 11832 | 12216 | 12576 | 12960 | 13536 | 13536 | 14112 | 14688 |
| 18 | 12216 | 12576 | 12960 | 13536 | 14112 | 14112 | 14688 | 15264 | 15264 | 15840 |
| 19 | 13536 | 13536 | 14112 | 14688 | 15264 | 15264 | 15840 | 16416 | 16992 | 16992 |
| 20 | 14688 | 14688 | 15264 | 15840 | 16416 | 16992 | 16992 | 17568 | 18336 | 18336 |
| 21 | 15840 | 15840 | 16416 | 16992 | 17568 | 18336 | 18336 | 19080 | 19848 | 19848 |
| 22 | 16992 | 16992 | 17568 | 18336 | 19080 | 19080 | 19848 | 20616 | 21384 | 21384 |
| 23 | 17568 | 18336 | 19080 | 19848 | 19848 | 20616 | 21384 | 22152 | 22152 | 22920 |
| 24 | 19080 | 19848 | 19848 | 20616 | 21384 | 22152 | 22920 | 22920 | 23688 | 24496 |
| 25 | 19848 | 20616 | 20616 | 21384 | 22152 | 22920 | 23688 | 24496 | 24496 | 25456 |
| 26 | 22920 | 23688 | 24496 | 25456 | 25456 | 26416 | 27376 | 28336 | 29296 | 29296 |
| | N_{PRB} | | | | | | | | | |
| I_{TBS} | 41 | 42 | 43 | 44 | 45 | 46 | 47 | 48 | 49 | 50 |
| 0 | 1128 | 1160 | 1192 | 1224 | 1256 | 1256 | 1288 | 1320 | 1352 | 1384 |
| 1 | 1480 | 1544 | 1544 | 1608 | 1608 | 1672 | 1736 | 1736 | 1800 | 1800 |
| 2 | 1800 | 1864 | 1928 | 1992 | 2024 | 2088 | 2088 | 2152 | 2216 | 2216 |
| 3 | 2408 | 2472 | 2536 | 2536 | 2600 | 2664 | 2728 | 2792 | 2856 | 2856 |
| 4 | 2984 | 2984 | 3112 | 3112 | 3240 | 3240 | 3368 | 3496 | 3496 | 3624 |
| 5 | 3624 | 3752 | 3752 | 3880 | 4008 | 4008 | 4136 | 4264 | 4392 | 4392 |
| 6 | 4264 | 4392 | 4584 | 4584 | 4776 | 4776 | 4968 | 4968 | 5160 | 5160 |
| 7 | 4968 | 5160 | 5352 | 5352 | 5544 | 5736 | 5736 | 5992 | 5992 | 6200 |
| 8 | 5736 | 5992 | 5992 | 6200 | 6200 | 6456 | 6456 | 6712 | 6968 | 6968 |
| 9 | 6456 | 6712 | 6712 | 6968 | 6968 | 7224 | 7480 | 7480 | 7736 | 7992 |
| 10 | 7224 | 7480 | 7480 | 7736 | 7992 | 7992 | 8248 | 8504 | 8504 | 8760 |
| 11 | 8248 | 8504 | 8760 | 8760 | 9144 | 9144 | 9528 | 9528 | 9912 | 9912 |
| 12 | 9528 | 9528 | 9912 | 9912 | 10296 | 10680 | 10680 | 11064 | 11064 | 11448 |
| 13 | 10680 | 10680 | 11064 | 11448 | 11448 | 11832 | 12216 | 12216 | 12576 | 12960 |
| 14 | 11832 | 12216 | 12216 | 12576 | 12960 | 12960 | 13536 | 13536 | 14112 | 14112 |
| 15 | 12576 | 12960 | 12960 | 13536 | 13536 | 14112 | 14688 | 14688 | 15264 | 15264 |
| 16 | 13536 | 13536 | 14112 | 14112 | 14688 | 14688 | 15264 | 15840 | 15840 | 16416 |
| 17 | 14688 | 15264 | 15264 | 15840 | 16416 | 16416 | 16992 | 17568 | 17568 | 18336 |
| 18 | 16416 | 16416 | 16992 | 17568 | 17568 | 18336 | 18336 | 19080 | 19080 | 19848 |
| 19 | 17568 | 18336 | 18336 | 19080 | 19080 | 19848 | 20616 | 20616 | 21384 | 21384 |
| 20 | 19080 | 19848 | 19848 | 20616 | 20616 | 21384 | 22152 | 22152 | 22920 | 22920 |
| 21 | 20616 | 21384 | 21384 | 22152 | 22920 | 22920 | 23688 | 24496 | 24496 | 25456 |
| 22 | 22152 | 22920 | 22920 | 23688 | 24496 | 24496 | 25456 | 25456 | 26416 | 27376 |
| 23 | 23688 | 24496 | 24496 | 25456 | 25456 | 26416 | 27376 | 27376 | 28336 | 28336 |
| 24 | 25456 | 25456 | 26416 | 26416 | 27376 | 28336 | 28336 | 29296 | 29296 | 30576 |
| 25 | 26416 | 26416 | 27376 | 28336 | 28336 | 29296 | 29296 | 30576 | 31704 | 31704 |
| 26 | 30576 | 30576 | 31704 | 32856 | 32856 | 34008 | 35160 | 35160 | 36696 | 36696 |
| | N_{PRB} | | | | | | | | | |
| I_{TBS} | 51 | 52 | 53 | 54 | 55 | 56 | 57 | 58 | 59 | 60 |
| 0 | 1416 | 1416 | 1480 | 1480 | 1544 | 1544 | 1608 | 1608 | 1608 | 1672 |
| 1 | 1864 | 1864 | 1928 | 1992 | 1992 | 2024 | 2088 | 2088 | 2152 | 2152 |
| 2 | 2280 | 2344 | 2344 | 2408 | 2472 | 2536 | 2536 | 2600 | 2664 | 2664 |
| 3 | 2984 | 2984 | 3112 | 3112 | 3240 | 3240 | 3368 | 3368 | 3496 | 3496 |
| 4 | 3624 | 3752 | 3752 | 3880 | 4008 | 4008 | 4136 | 4136 | 4264 | 4264 |
| 5 | 4584 | 4584 | 4776 | 4776 | 4776 | 4968 | 4968 | 5160 | 5160 | 5352 |
| 6 | 5352 | 5352 | 5544 | 5736 | 5736 | 5992 | 5992 | 5992 | 6200 | 6200 |
| 7 | 6200 | 6456 | 6456 | 6712 | 6712 | 6712 | 6968 | 6968 | 7224 | 7224 |
| 8 | 7224 | 7224 | 7480 | 7480 | 7736 | 7736 | 7992 | 7992 | 8248 | 8504 |
| 9 | 7992 | 8248 | 8248 | 8504 | 8760 | 8760 | 9144 | 9144 | 9144 | 9528 |
| 10 | 9144 | 9144 | 9144 | 9528 | 9528 | 9912 | 9912 | 10296 | 10296 | 10680 |
| 11 | 10296 | 10680 | 10680 | 11064 | 11064 | 11448 | 11448 | 11832 | 11832 | 12216 |
| 12 | 11832 | 11832 | 12216 | 12216 | 12576 | 12576 | 12960 | 12960 | 13536 | 13536 |
| 13 | 12960 | 13536 | 13536 | 14112 | 14112 | 14688 | 14688 | 14688 | 15264 | 15264 |
| 14 | 14688 | 14688 | 15264 | 15264 | 15840 | 15840 | 16416 | 16416 | 16992 | 16992 |
| 15 | 15840 | 15840 | 16416 | 16416 | 16992 | 16992 | 17568 | 17568 | 18336 | 18336 |
| 16 | 16416 | 16992 | 16992 | 17568 | 17568 | 18336 | 18336 | 19080 | 19080 | 19848 |
| 17 | 18336 | 19080 | 19080 | 19848 | 19848 | 20616 | 20616 | 20616 | 21384 | 21384 |
| 18 | 19848 | 20616 | 21384 | 21384 | 22152 | 22152 | 22920 | 22920 | 23688 | 23688 |
| 19 | 22152 | 22152 | 22920 | 22920 | 23688 | 24496 | 24496 | 25456 | 25456 | 25456 |
| 20 | 23688 | 24496 | 24496 | 25456 | 25456 | 26416 | 26416 | 27376 | 27376 | 28336 |
| 21 | 25456 | 26416 | 26416 | 27376 | 27376 | 28336 | 28336 | 29296 | 29296 | 30576 |
| 22 | 27376 | 28336 | 28336 | 29296 | 29296 | 30576 | 30576 | 31704 | 31704 | 32856 |
| 23 | 29296 | 29296 | 30576 | 30576 | 31704 | 31704 | 32856 | 32856 | 34008 | 34008 |
| 24 | 31704 | 31704 | 32856 | 32856 | 34008 | 34008 | 35160 | 35160 | 36696 | 36696 |
| 25 | 32856 | 32856 | 34008 | 34008 | 35160 | 35160 | 36696 | 36696 | 37888 | 37888 |
| 26 | 37888 | 37888 | 39232 | 40576 | 40576 | 40576 | 42368 | 42368 | 43816 | 43816 |
| | N_{PRB} | | | | | | | | | |
| I_{TBS} | 61 | 62 | 63 | 64 | 65 | 66 | 67 | 68 | 69 | 70 |
| 0 | 1672 | 1736 | 1736 | 1800 | 1800 | 1800 | 1864 | 1864 | 1928 | 1928 |
| 1 | 2216 | 2280 | 2280 | 2344 | 2344 | 2408 | 2472 | 2472 | 2536 | 2536 |
| 2 | 2728 | 2792 | 2856 | 2856 | 2856 | 2984 | 2984 | 3112 | 3112 | 3112 |
| 3 | 3624 | 3624 | 3624 | 3752 | 3752 | 3880 | 3880 | 4008 | 4008 | 4136 |
| 4 | 4392 | 4392 | 4584 | 4584 | 4584 | 4776 | 4776 | 4968 | 4968 | 4968 |
| 5 | 5352 | 5544 | 5544 | 5736 | 5736 | 5736 | 5992 | 5992 | 5992 | 6200 |
| 6 | 6456 | 6456 | 6456 | 6712 | 6712 | 6968 | 6968 | 6968 | 7224 | 7224 |
| 7 | 7480 | 7480 | 7736 | 7736 | 7992 | 7992 | 8248 | 8248 | 8504 | 8504 |
| 8 | 8504 | 8760 | 8760 | 9144 | 9144 | 9144 | 9528 | 9528 | 9528 | 9912 |
| 9 | 9528 | 9912 | 9912 | 10296 | 10296 | 10296 | 10680 | 10680 | 11064 | 11064 |
| 10 | 10680 | 11064 | 11064 | 11448 | 11448 | 11448 | 11832 | 11832 | 12216 | 12216 |
| 11 | 12216 | 12576 | 12576 | 12960 | 12960 | 13536 | 13536 | 13536 | 14112 | 14112 |
| 12 | 14112 | 14112 | 14112 | 14688 | 14688 | 15264 | 15264 | 15264 | 15840 | 15840 |
| 13 | 15840 | 15840 | 16416 | 16416 | 16992 | 16992 | 16992 | 17568 | 17568 | 18336 |
| 14 | 17568 | 17568 | 18336 | 18336 | 18336 | 19080 | 19080 | 19848 | 19848 | 19848 |
| 15 | 18336 | 19080 | 19080 | 19848 | 19848 | 20616 | 20616 | 20616 | 21384 | 21384 |
| 16 | 19848 | 19848 | 20616 | 20616 | 21384 | 21384 | 22152 | 22152 | 22152 | 22920 |
| 17 | 22152 | 22152 | 22920 | 22920 | 23688 | 23688 | 24496 | 24496 | 24496 | 25456 |
| 18 | 24496 | 24496 | 24496 | 25456 | 25456 | 26416 | 26416 | 27376 | 27376 | 27376 |
| 19 | 26416 | 26416 | 27376 | 27376 | 28336 | 28336 | 29296 | 29296 | 29296 | 30576 |
| 20 | 28336 | 29296 | 29296 | 29296 | 30576 | 30576 | 31704 | 31704 | 31704 | 32856 |
| 21 | 30576 | 31704 | 31704 | 31704 | 32856 | 32856 | 34008 | 34008 | 35160 | 35160 |
| 22 | 32856 | 34008 | 34008 | 34008 | 35160 | 35160 | 36696 | 36696 | 36696 | 37888 |
| 23 | 35160 | 35160 | 36696 | 36696 | 37888 | 37888 | 37888 | 39232 | 39232 | 40576 |
| 24 | 36696 | 37888 | 37888 | 39232 | 39232 | 40576 | 40576 | 42368 | 42368 | 42368 |
| 25 | 39232 | 39232 | 40576 | 40576 | 40576 | 42368 | 42368 | 43816 | 43816 | 43816 |
| 26 | 45352 | 45352 | 46888 | 46888 | 48936 | 48936 | 48936 | 51024 | 51024 | 52752 |
| | N_{PRB} | | | | | | | | | |
| I_{TBS} | 71 | 72 | 73 | 74 | 75 | 76 | 77 | 78 | 79 | 80 |
| 0 | 1992 | 1992 | 2024 | 2088 | 2088 | 2088 | 2152 | 2152 | 2216 | 2216 |
| 1 | 2600 | 2600 | 2664 | 2728 | 2728 | 2792 | 2792 | 2856 | 2856 | 2856 |
| 2 | 3240 | 3240 | 3240 | 3368 | 3368 | 3368 | 3496 | 3496 | 3496 | 3624 |
| 3 | 4136 | 4264 | 4264 | 4392 | 4392 | 4392 | 4584 | 4584 | 4584 | 4776 |
| 4 | 5160 | 5160 | 5160 | 5352 | 5352 | 5544 | 5544 | 5544 | 5736 | 5736 |
| 5 | 6200 | 6200 | 6456 | 6456 | 6712 | 6712 | 6712 | 6968 | 6968 | 6968 |
| 6 | 7480 | 7480 | 7736 | 7736 | 7736 | 7992 | 7992 | 8248 | 8248 | 8248 |
| 7 | 8760 | 8760 | 8760 | 9144 | 9144 | 9144 | 9528 | 9528 | 9528 | 9912 |
| 8 | 9912 | 9912 | 10296 | 10296 | 10680 | 10680 | 10680 | 11064 | 11064 | 11064 |
| 9 | 11064 | 11448 | 11448 | 11832 | 11832 | 11832 | 12216 | 12216 | 12576 | 12576 |
| 10 | 12576 | 12576 | 12960 | 12960 | 12960 | 13536 | 13536 | 13536 | 14112 | 14112 |
| 11 | 14112 | 14688 | 14688 | 14688 | 15264 | 15264 | 15840 | 15840 | 15840 | 16416 |
| 12 | 16416 | 16416 | 16416 | 16992 | 16992 | 17568 | 17568 | 17568 | 18336 | 18336 |
| 13 | 18336 | 18336 | 19080 | 19080 | 19080 | 19848 | 19848 | 19848 | 20616 | 20616 |
| 14 | 20616 | 20616 | 20616 | 21384 | 21384 | 22152 | 22152 | 22152 | 22920 | 22920 |
| 15 | 22152 | 22152 | 22152 | 22920 | 22920 | 23688 | 23688 | 23688 | 24496 | 24496 |
| 16 | 22920 | 23688 | 23688 | 24496 | 24496 | 24496 | 25456 | 25456 | 25456 | 26416 |
| 17 | 25456 | 26416 | 26416 | 26416 | 27376 | 27376 | 27376 | 28336 | 28336 | 29296 |
| 18 | 28336 | 28336 | 29296 | 29296 | 29296 | 30576 | 30576 | 30576 | 31704 | 31704 |
| 19 | 30576 | 30576 | 31704 | 31704 | 32856 | 32856 | 32856 | 34008 | 34008 | 34008 |
| 20 | 32856 | 34008 | 34008 | 34008 | 35160 | 35160 | 35160 | 36696 | 36696 | 36696 |
| 21 | 35160 | 36696 | 36696 | 36696 | 37888 | 37888 | 39232 | 39232 | 39232 | 40576 |
| 22 | 37888 | 39232 | 39232 | 40576 | 40576 | 40576 | 42368 | 42368 | 42368 | 43816 |
| 23 | 40576 | 40576 | 42368 | 42368 | 43816 | 43816 | 43816 | 45352 | 45352 | 45352 |
| 24 | 43816 | 43816 | 45352 | 45352 | 45352 | 46888 | 46888 | 46888 | 48936 | 48936 |
| 25 | 45352 | 45352 | 46888 | 46888 | 46888 | 48936 | 48936 | 48936 | 51024 | 51024 |
| 26 | 52752 | 52752 | 55056 | 55056 | 55056 | 55056 | 57336 | 57336 | 57336 | 59256 |

| | N_{PRB} | | | | | | | | | |
|---|---|---|---|---|---|---|---|---|---|---|
| I_{TBS} | 81 | 82 | 83 | 84 | 85 | 86 | 87 | 88 | 89 | 90 |
| 0 | 2280 | 2280 | 2280 | 2344 | 2344 | 2408 | 2408 | 2472 | 2472 | 2536 |
| 1 | 2984 | 2984 | 2984 | 3112 | 3112 | 3112 | 3240 | 3240 | 3240 | 3240 |
| 2 | 3624 | 3624 | 3752 | 3752 | 3880 | 3880 | 3880 | 4008 | 4008 | 4008 |
| 3 | 4776 | 4776 | 4776 | 4968 | 4968 | 4968 | 5160 | 5160 | 5160 | 5352 |
| 4 | 5736 | 5992 | 5992 | 5992 | 5992 | 6200 | 6200 | 6200 | 6456 | 6456 |
| 5 | 7224 | 7224 | 7224 | 7480 | 7480 | 7480 | 7736 | 7736 | 7736 | 7992 |
| 6 | 8504 | 8504 | 8760 | 8760 | 8760 | 9144 | 9144 | 9144 | 9144 | 9528 |
| 7 | 9912 | 9912 | 10296 | 10296 | 10296 | 10680 | 10680 | 10680 | 11064 | 11064 |
| 8 | 11448 | 11448 | 11448 | 11832 | 11832 | 12216 | 12216 | 12216 | 12576 | 12576 |
| 9 | 12960 | 12960 | 12960 | 13536 | 13536 | 13536 | 13536 | 14112 | 14112 | 14112 |
| 10 | 14112 | 14688 | 14688 | 14688 | 14688 | 15264 | 15264 | 15264 | 15840 | 15840 |
| 11 | 16416 | 16416 | 16992 | 16992 | 16992 | 17568 | 17568 | 17568 | 18336 | 18336 |
| 12 | 18336 | 19080 | 19080 | 19080 | 19080 | 19848 | 19848 | 19848 | 20616 | 20616 |
| 13 | 20616 | 21384 | 21384 | 21384 | 22152 | 22152 | 22152 | 22920 | 22920 | 22920 |
| 14 | 22920 | 23688 | 23688 | 24496 | 24496 | 24496 | 25456 | 25456 | 25456 | 25456 |
| 15 | 24496 | 25456 | 25456 | 25456 | 26416 | 26416 | 26416 | 27376 | 27376 | 27376 |
| 16 | 26416 | 26416 | 27376 | 27376 | 27376 | 28336 | 28336 | 28336 | 29296 | 29296 |
| 17 | 29296 | 29296 | 30576 | 30576 | 30576 | 30576 | 31704 | 31704 | 31704 | 32856 |
| 18 | 31704 | 32856 | 32856 | 32856 | 34008 | 34008 | 34008 | 35160 | 35160 | 35160 |
| 19 | 35160 | 35160 | 35160 | 36696 | 36696 | 36696 | 37888 | 37888 | 37888 | 39232 |
| 20 | 37888 | 37888 | 39232 | 39232 | 39232 | 40576 | 40576 | 40576 | 42368 | 42368 |
| 21 | 40576 | 40576 | 42368 | 42368 | 42368 | 43816 | 43816 | 43816 | 45352 | 45352 |
| 22 | 43816 | 43816 | 45352 | 45352 | 45352 | 46888 | 46888 | 46888 | 48936 | 48936 |
| 23 | 46888 | 46888 | 46888 | 48936 | 48936 | 48936 | 51024 | 51024 | 51024 | 51024 |
| 24 | 48936 | 51024 | 51024 | 51024 | 52752 | 52752 | 52752 | 52752 | 55056 | 55056 |
| 25 | 51024 | 52752 | 52752 | 52752 | 55056 | 55056 | 55056 | 55056 | 57336 | 57336 |
| 26 | 59256 | 59256 | 61664 | 61664 | 61664 | 63776 | 63776 | 63776 | 66592 | 66592 |

| | N_{PRB} | | | | | | | | | |
|---|---|---|---|---|---|---|---|---|---|---|
| I_{TBS} | 91 | 92 | 93 | 94 | 95 | 96 | 97 | 98 | 99 | 100 |
| 0 | 2536 | 2536 | 2600 | 2600 | 2664 | 2664 | 2728 | 2728 | 2728 | 2792 |
| 1 | 3368 | 3368 | 3368 | 3496 | 3496 | 3496 | 3496 | 3624 | 3624 | 3624 |
| 2 | 4136 | 4136 | 4136 | 4264 | 4264 | 4264 | 4392 | 4392 | 4392 | 4584 |
| 3 | 5352 | 5352 | 5352 | 5544 | 5544 | 5544 | 5736 | 5736 | 5736 | 5736 |
| 4 | 6456 | 6456 | 6712 | 6712 | 6712 | 6968 | 6968 | 6968 | 6968 | 7224 |
| 5 | 7992 | 7992 | 8248 | 8248 | 8248 | 8504 | 8504 | 8760 | 8760 | 8760 |
| 6 | 9528 | 9528 | 9528 | 9912 | 9912 | 9912 | 10296 | 10296 | 10296 | 10296 |
| 7 | 11064 | 11448 | 11448 | 11448 | 11448 | 11832 | 11832 | 11832 | 12216 | 12216 |
| 8 | 12576 | 12960 | 12960 | 12960 | 13536 | 13536 | 13536 | 13536 | 14112 | 14112 |
| 9 | 14112 | 14688 | 14688 | 14688 | 15264 | 15264 | 15264 | 15264 | 15840 | 15840 |
| 10 | 15840 | 16416 | 16416 | 16416 | 16992 | 16992 | 16992 | 16992 | 17568 | 17568 |
| 11 | 18336 | 18336 | 19080 | 19080 | 19080 | 19080 | 19848 | 19848 | 19848 | 19848 |
| 12 | 20616 | 21384 | 21384 | 21384 | 21384 | 22152 | 22152 | 22152 | 22920 | 22920 |
| 13 | 23688 | 23688 | 23688 | 24496 | 24496 | 24496 | 25456 | 25456 | 25456 | 25456 |
| 14 | 26416 | 26416 | 26416 | 27376 | 27376 | 27376 | 28336 | 28336 | 28336 | 28336 |
| 15 | 28336 | 28336 | 28336 | 29296 | 29296 | 29296 | 29296 | 30576 | 30576 | 30576 |
| 16 | 29296 | 30576 | 30576 | 30576 | 30576 | 31704 | 31704 | 31704 | 31704 | 32856 |
| 17 | 32856 | 32856 | 34008 | 34008 | 34008 | 35160 | 35160 | 35160 | 35160 | 36696 |
| 18 | 36696 | 36696 | 36696 | 37888 | 37888 | 37888 | 37888 | 39232 | 39232 | 39232 |
| 19 | 39232 | 39232 | 40576 | 40576 | 40576 | 40576 | 42368 | 42368 | 42368 | 43816 |
| 20 | 42368 | 42368 | 43816 | 43816 | 43816 | 45352 | 45352 | 45352 | 46888 | 46888 |
| 21 | 45352 | 46888 | 46888 | 46888 | 46888 | 48936 | 48936 | 48936 | 48936 | 51024 |
| 22 | 48936 | 48936 | 51024 | 51024 | 51024 | 51024 | 52752 | 52752 | 52752 | 55056 |
| 23 | 52752 | 52752 | 52752 | 55056 | 55056 | 55056 | 55056 | 57336 | 57336 | 57336 |
| 24 | 55056 | 57336 | 57336 | 57336 | 57336 | 59256 | 59256 | 59256 | 61664 | 61664 |
| 25 | 57336 | 59256 | 59256 | 59256 | 61664 | 61664 | 61664 | 61664 | 63776 | 63776 |
| 26 | 66592 | 68808 | 68808 | 68808 | 71112 | 71112 | 71112 | 73712 | 73712 | 75376 |

| | N_{PRB} | | | | | | | | | |
|---|---|---|---|---|---|---|---|---|---|---|
| I_{TBS} | 101 | 102 | 103 | 104 | 105 | 106 | 107 | 108 | 109 | 110 |
| 0 | 2792 | 2856 | 2856 | 2856 | 2984 | 2984 | 2984 | 2984 | 2984 | 3112 |
| 1 | 3752 | 3752 | 3752 | 3752 | 3880 | 3880 | 3880 | 4008 | 4008 | 4008 |
| 2 | 4584 | 4584 | 4584 | 4584 | 4776 | 4776 | 4776 | 4776 | 4968 | 4968 |
| 3 | 5992 | 5992 | 5992 | 5992 | 6200 | 6200 | 6200 | 6200 | 6456 | 6456 |
| 4 | 7224 | 7224 | 7480 | 7480 | 7480 | 7480 | 7736 | 7736 | 7736 | 7992 |
| 5 | 8760 | 9144 | 9144 | 9144 | 9144 | 9528 | 9528 | 9528 | 9528 | 9528 |
| 6 | 10680 | 10680 | 10680 | 10680 | 11064 | 11064 | 11064 | 11448 | 11448 | 11448 |
| 7 | 12216 | 12576 | 12576 | 12576 | 12960 | 12960 | 12960 | 12960 | 13536 | 13536 |
| 8 | 14112 | 14112 | 14688 | 14688 | 14688 | 14688 | 15264 | 15264 | 15264 | 15264 |
| 9 | 15840 | 16416 | 16416 | 16416 | 16416 | 16992 | 16992 | 16992 | 16992 | 17568 |
| 10 | 17568 | 18336 | 18336 | 18336 | 18336 | 18336 | 19080 | 19080 | 19080 | 19080 |
| 11 | 20616 | 20616 | 20616 | 21384 | 21384 | 21384 | 21384 | 22152 | 22152 | 22152 |
| 12 | 22920 | 23688 | 23688 | 23688 | 23688 | 24496 | 24496 | 24496 | 24496 | 25456 |
| 13 | 26416 | 26416 | 26416 | 26416 | 27376 | 27376 | 27376 | 27376 | 28336 | 28336 |
| 14 | 29296 | 29296 | 29296 | 29296 | 30576 | 30576 | 30576 | 30576 | 31704 | 31704 |
| 15 | 30576 | 31704 | 31704 | 31704 | 31704 | 32856 | 32856 | 32856 | 34008 | 34008 |
| 16 | 32856 | 32856 | 34008 | 34008 | 34008 | 34008 | 35160 | 35160 | 35160 | 35160 |
| 17 | 36696 | 36696 | 36696 | 37888 | 37888 | 37888 | 39232 | 39232 | 39232 | 39232 |
| 18 | 40576 | 40576 | 40576 | 40576 | 42368 | 42368 | 42368 | 42368 | 43816 | 43816 |
| 19 | 43816 | 43816 | 43816 | 45352 | 45352 | 45352 | 46888 | 46888 | 46888 | 46888 |
| 20 | 46888 | 46888 | 48936 | 48936 | 48936 | 48936 | 48936 | 51024 | 51024 | 51024 |
| 21 | 51024 | 51024 | 51024 | 52752 | 52752 | 52752 | 52752 | 55056 | 55056 | 55056 |
| 22 | 55056 | 55056 | 55056 | 57336 | 57336 | 57336 | 57336 | 59256 | 59256 | 59256 |
| 23 | 57336 | 59256 | 59256 | 59256 | 59256 | 61664 | 61664 | 61664 | 61664 | 63776 |
| 24 | 61664 | 61664 | 63776 | 63776 | 63776 | 63776 | 66592 | 66592 | 66592 | 66592 |
| 25 | 63776 | 63776 | 66592 | 66592 | 66592 | 66592 | 68808 | 68808 | 68808 | 71112 |
| 26 | 75376 | 75376 | 75376 | 75376 | 75376 | 75376 | 75376 | 75376 | 75376 | 75376 |

N_{PRB} in the first transport block size table represents the number of the physical resource block pairs, I_{TBS} represents the TBS index value, and an element in the table represents the transport block size TBS.

Further, the set conversion factor may include a first set conversion factor corresponding to a first modulation and coding scheme level and a second set conversion factor corresponding to a second modulation and coding scheme level in the transport block size table, and the first set conversion factor is different from the second set conversion factor.

Specifically, the conversion factor may include, for example, one type of conversion factor corresponding to a class 1 modulation and coding scheme level and another type of conversion factor corresponding to a class 2 modulation and coding scheme level in the transport block size table. That is, if the MCS level determined by the base station is the class 1 modulation and coding scheme level, the number of the second physical resource block pairs is the number of the first physical resource block pairs multiplied by a conversion factor corresponding to the class 1 modulation and coding scheme level; and if the MCS level determined by the base station is the class 2 modulation and coding scheme level, the number of the second physical resource block pairs is the number of the first physical resource block pairs multiplied by a conversion factor corresponding to the class 2 modulation and coding scheme level.

In other embodiments, there may be multiple conversion factors, which respectively correspond to multiple classes of MCS levels. Methods for determining classes of the MCS levels may further vary with system overheads.

Based on the foregoing embodiment, furthermore, the first modulation and coding scheme level may be a maximum modulation and coding scheme level in the transport block size table; and the second modulation and coding scheme level may be a non-maximum modulation and coding scheme level in the transport block size table.

Specifically, the first modulation and coding scheme level may be the maximum modulation and coding scheme level in the transport block size table; and the second modulation and coding scheme level may be the non-maximum modulation and coding scheme level in the transport block size table. In other embodiments, the first modulation and coding scheme level may further be the maximum modulation and coding scheme level in the transport block size table and any other one or more coding levels.

Based on the foregoing embodiment, furthermore, the first set conversion factor may be 1.1; and the second set conversion factor may be 1.3.

For example, if the MCS level determined by the base station is 8, the number of the first physical resource block pairs is 11, and the system overhead is 12 resource elements, the base station selects, from the transport block size table, the TBS corresponding to the modulation and coding scheme level and corresponding to the number of the second physical resource block pairs, and the number of the second physical resource block pairs is a product of the number of the first physical resource block pairs 11 and the set conversion factor. Further, because the MCS level 8 is a non-maximum modulation and coding scheme level, and the set conversion factor is 1.3, the number of the second physical resource block pairs is 11 multiplied by 1.3, which equals 14.3. In this case, the base station may round off the number 14.3 of the second physical resource block pairs to an integer, where a rounding-off process may be rounding up to an integer or rounding down to an integer. In the transport block size table, a TBS corresponding to the MCS level 8 and corresponding to the number of the physical resource block pairs 14 is determined, the service data is modulated onto the determined TBS and is transmitted to the UE, and the UE is notified that the MCS level is 8 and that the number of the physical resource block pairs determined by the base station is 11, so that the UE receives the service data according to the MCS level and the number of the physical resource block pairs.

Further, if the number of the second physical resource block pairs is larger than the maximum number of physical resource block pairs of the transport block size table, the TBS corresponding to the modulation and coding scheme level and corresponding to the number of the second physical resource block pairs is a TBS corresponding to the modulation and coding scheme level and corresponding to the maximum number of the physical resource block pairs.

Specifically, for example, when the product of the number of the first physical resource block pairs and the set conversion factor is larger than the maximum number of the physical resource block pairs included in the transport block size table, the TBS corresponding to the modulation and coding scheme level and corresponding to the number of the second physical resource block pairs is the TBS corresponding to the modulation and coding scheme level and corresponding to the maximum number of the physical resource block pairs.

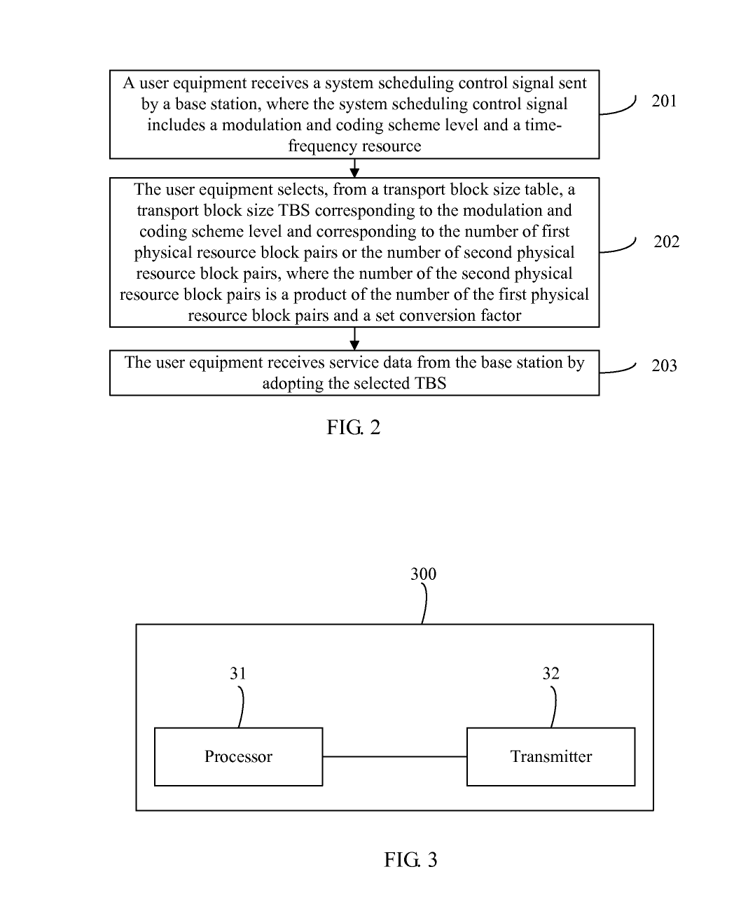

FIG. 2 is a method flowchart of a second embodiment of a data transmission method of the present invention. As shown in FIG. 2, the data transmission method of this embodiment includes:

201: A user equipment receives a system scheduling control signal sent by a base station, where the system scheduling control signal includes a modulation and coding scheme level and a time-frequency resource.

202: The user equipment selects, from a transport block size table, a transport block size TBS corresponding to the modulation and coding scheme level and corresponding to the number of first physical resource block pairs or the number of second physical resource block pairs, where the number of the second physical resource block pairs is a product of the number of the first physical resource block pairs and a set conversion factor.

The user equipment (User Equipment, UE for short) may firstly determine, according to the determined MCS level and in the transport block size index table (Modulation and TBS index table for PDSCH), a modulation order index value and a TBS index value corresponding to the MCS level; and then select, from the transport block size table, the transport block size (Transport block size, TBS for short) corresponding to the MCS level and corresponding to the number of the first physical resource block pairs determined in step 202.

Alternatively, the UE may firstly determine, according to the determined MCS level, in the transport block size index table (Modulation and TBS index table for PDSCH), a modulation order index value and a TBS index value corresponding to the MCS level; and then, select, from the transport block size table, the TBS corresponding to the MCS level and corresponding to the number of the second physical resource block pairs.

The number of the first physical resource block pairs is the number of the physical resource block pairs determined by the UE according to the time-frequency resource included in the received system scheduling control signal, and the number of the second physical resource block pairs is a product of the number of the first physical resource block pairs and the set conversion factor.

203: The user equipment receives service data from the base station by adopting the selected TBS.

In the data transmission method of this embodiment, the user equipment receives a system scheduling control signal sent by the base station, where the system scheduling control signal includes a modulation and coding scheme level and a time-frequency resource; and selects, from a transport block size table, a transport block size TBS corresponding to the modulation and coding scheme level and corresponding to the number of first physical resource block pairs or the number of second physical resource block pairs, where the number of the second physical resource block pairs is a product of the number of the first physical resource block pairs and a set conversion factor. The user equipment receives service data from the base station by adopting the selected TBS. In this way, a selection of the TBS by the user equipment is implemented, so that an expected coding rate can be achieved when the user equipment receives the service data transmitted by the base station according to the selected TBS, and system throughput is improved.

Further, that the user equipment selects, from a transport block size table, a transport block size TBS corresponding to the modulation and coding scheme level and corresponding to the number of first physical resource block pairs or corresponding to the number of second physical resource block pairs, includes that: the user equipment selects, according to a system configuration parameter or a system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

Specifically, the UE may select, according to the system configuration parameter, the TBS corresponding to the modulation and coding scheme level and corresponding to the number of the first physical resource block pairs, or, select the TBS corresponding to the modulation and coding scheme level and corresponding to the number of the second physical resource block pairs.

For example, when the system configuration parameter indicates that control signaling contains a physical downlink control channel, it indicates that the system instructs the UE to select the TBS corresponding to the modulation and coding scheme level and corresponding to the number of the first physical resource block pairs; and when the system configuration parameter indicates that the control signaling does not contain the physical downlink control channel, it indicates that the system instructs the UE to select the TBS corresponding to the modulation and coding scheme level and corresponding to the number of the second physical resource block pairs.

Alternatively, the UE may select, according to the system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

For example, when the system overhead size is 48 resource elements, it indicates that the system instructs the UE to select the TBS corresponding to the modulation and coding scheme level and corresponding to the number of the first physical resource block pairs; and when the system overhead is 12 resource elements, it indicates that the system instructs the UE to select the TBS corresponding to the modulation and coding scheme level and corresponding to the number of the second physical resource block pairs.

Further, the user equipment receives a higher-layer signaling message sent by the base station, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

Specifically, the higher-layer signaling message received by the UE from the base station may carry the instruction information of instructing the UE to select the TBS corresponding to the modulation and coding scheme level and corresponding to the number of the first physical resource block pairs, or, to select the TBS corresponding to the modulation and coding scheme level and corresponding to the number of the second physical resource block pairs.

Further, the user equipment receives a downlink control message sent by the base station, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs, which may increase a switching speed of the UE among different selections.

Further, the transport block size table includes: a transport block size table of layer 1 data in a Long Term Evolution Release 8 LTE REL.8 system. The transport block size table of layer 1 data in the LTE REL.8 is shown in Table 1. Reference may be made to Table 1, and details are not described herein again.

Further, the set conversion factor includes a first set conversion factor corresponding to a first modulation and coding scheme level and a second set conversion factor corresponding to a second modulation and coding scheme level in the transport block size table, and the first set conversion factor is different from the second set conversion factor.

Specifically, the conversion factor may include, for example, one type of conversion factor corresponding to a class 1 modulation and coding scheme level and another type of conversion factor corresponding to a class 2 modulation and coding scheme level in the transport block size table. That is, if the MCS level included in the system scheduling control signal received by the UE is the class 1 modulation and coding scheme level, the number of the second physical resource block pairs is a product of the number of the first physical resource block pairs multiplied by a conversion factor corresponding to the class 1 modulation and coding scheme level; and if the MCS level included in the system scheduling control signal received by the UE is the class 2 modulation and coding scheme level, the number of the second physical resource block pairs is the number of the first physical resource block pairs multiplied by a conversion factor corresponding to the class 2 modulation and coding scheme level.

In other embodiments, there may be multiple conversion factors, which respectively correspond to multiple classes of MCS levels. Methods for determining classes of the MCS levels may further vary with system overheads.

Based on the foregoing embodiment, furthermore, the first modulation and coding scheme level is a maximum modulation and coding scheme level in the transport block size table; and the second modulation and coding scheme level is a non-maximum modulation and coding scheme level in the transport block size table.

Specifically, the first modulation and coding scheme level may be the maximum modulation and coding scheme level in the transport block size table; and the second modulation and coding scheme level may be the non-maximum modulation and coding scheme level in the transport block size table. In other embodiments, the first modulation and coding scheme level may further be the maximum modulation and coding scheme level in the transport block size table and any other one or more coding levels.

Further, the first set conversion factor is 1.1; and the second set conversion factor is 1.3.

For example, if the UE determines, according to the system scheduling control signal sent by the base station, that the MCS level is 8, that the number of the first physical resource block pairs is 11 PRB pairs, and that the system overhead is 12 resource elements, the UE selects, from the transport block size table, the TBS corresponding to the modulation and coding scheme level and corresponding to the number of the second physical resource block pairs, and the number of the second physical resource block pairs is a product of the number of the first physical resource block pairs 11 and the set conversion factor. Further, because the MCS level 8 is a non-maximum modulation and coding scheme level, and the set conversion factor is 1.3, the number of the second physical resource block pairs is 11 multiplied by 1.3, which equals 14.3. In this case, the UE may round off the number 14.3 of the second physical resource block pairs to an integer, where a rounding-off process may be rounding up to an integer or rounding down to an integer and is the same as a rounding-off manner of the base station. That is, if the base station adopts rounding up to an integer, the UE also adopts rounding up to an integer; and if the base station adopts rounding down to an integer, the UE also adopts rounding down to an integer. In the transport block size table, a TBS corresponding to the MCS level 8 and corresponding to the number of the physical resource block pairs 14 is determined, and the UE receives the service data sent by the base station according to the TBS.

Further, if the number of the second physical resource block pairs is larger than the maximum number of physical resource block pairs of the transport block size table, the TBS corresponding to the modulation and coding scheme level and corresponding to the number of the second physical resource block pairs is a TBS corresponding to the modulation and coding scheme level and corresponding to the maximum number of the physical resource block pairs.

Specifically, for example, when the product of the number of the first physical resource block pairs and the set conversion factor is larger than the maximum number of the physical resource block pairs included in the transport block size table, the TBS corresponding to the modulation and coding scheme level and corresponding to the number of the second physical resource block pairs is the TBS corresponding to the modulation and coding scheme level and corresponding to the maximum number of the physical resource block pairs.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

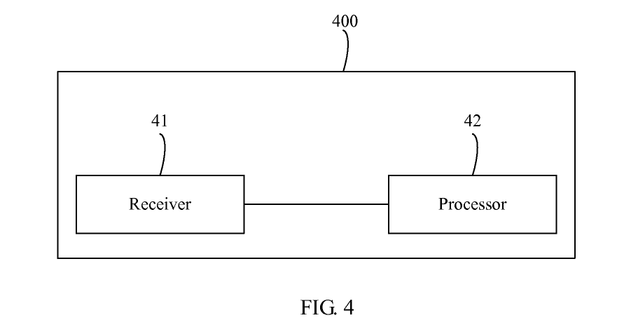

FIG. 3 is a schematic structural diagram of a first embodiment of a base station of the present invention. As shown in FIG. 3, a base station 300 of this embodiment includes: a processor 31 and a transmitter 32. The processor 31 may be configured to determine a modulation and coding scheme level; determine a time-frequency resource, and determine the number of first physical resource block pairs according to the time-frequency resource; and select, from a transport block size table, a transport block size TBS corresponding to the modulation and coding scheme level and corresponding to the number of first physical resource block pairs or the number of second physical resource block pairs, where the number of the second physical resource block pairs is a product of the number of the first physical resource block pairs and a set conversion factor. The transmitter 32 may be configured to send service data to a user equipment by adopting the selected TBS; and send a system scheduling control signal to the user equipment, where the system scheduling control signal includes the modulation and coding scheme level and the time-frequency resource.

In the base station of this embodiment, the processor 31 determines a modulation and coding scheme level; determines a time-frequency resource, and determines the number of first physical resource block pairs according to the time-frequency resource; and selects, from a transport block size table, a transport block size TBS corresponding to the modulation and coding scheme level and corresponding to the number of first physical resource block pairs or the number of second physical resource block pairs, where the number of the second physical resource block pairs is a product of the number of the first physical resource block pairs and a set conversion factor; and the transmitter sends service data to a user equipment by adopting the selected TBS; and sends a system scheduling control signal to the user equipment, where the system scheduling control signal includes the modulation and coding scheme level and the time-frequency resource. In this way, a selection of the TBS by the base station is implemented, so that an expected coding rate can be achieved when the base station transmits the service data to the UE according to the selected TBS, and system throughput is improved.

Further, the processor 31 may be further configured to select, according to a system configuration parameter or a system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

Further, the transmitter 32 may be further configured to transmit a higher-layer signaling message to the user equipment, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

Further, the transmitter 32 may be further configured to send a downlink control message to the user equipment, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

Further, the transport block size table may include: a transport block size table of layer 1 data in a Long Term Evolution Release 8 LTE REL.8 system.

Further, the set conversion factor may include a first set conversion factor corresponding to a first modulation and coding scheme level and a second set conversion factor corresponding to a second modulation and coding scheme level in the transport block size table, and the first set conversion factor is different from the second set conversion factor.

Further, the first modulation and coding scheme level is a maximum modulation and coding scheme level in the transport block size table; and the second modulation and coding scheme level is a non-maximum modulation and coding scheme level in the transport block size table.

Further, the first set conversion factor is 1.1; and the second set conversion factor is 1.3.

Further, the processor 31 may be further configured to, when the number of the second physical resource block pairs is larger than the maximum number of physical resource block pairs of the transport block size table, determine that the TBS corresponding to the modulation and coding scheme level and corresponding to the number of the second physical resource block pairs is the TBS corresponding to the modulation and coding scheme level and corresponding to the maximum number of the physical resource block pairs.

FIG. 4 is a schematic structural diagram of a first embodiment of a user equipment of the present invention. As shown in FIG. 4, a user equipment 400 of this embodiment includes: a receiver 41 and a processor 42. The receiver 41 may be configured to receive a system scheduling control signal sent by a base station, where the system scheduling control signal includes a modulation and coding scheme level and a time-frequency resource. The processor 42 may be configured to select, from a transport block size table, a transport block size TBS corresponding to the modulation and coding scheme level and corresponding to the number of first physical resource block pairs or corresponding to the number of second physical resource block pairs, where the number of the second physical resource block pairs is a product of the number of the first physical resource block pairs and a set conversion factor; and receive service data from the base station by adopting the selected TBS.

In the user equipment of this embodiment, a receiver receives a system scheduling control signal sent by a base station, where the system scheduling control signal includes a modulation and coding scheme level and a time-frequency resource; and a processor selects, from a transport block size table, a transport block size TBS corresponding to the modulation and coding scheme level and corresponding to the number of first physical resource block pairs or the number of second physical resource block pairs, where the number of the second physical resource block pairs is a product of the number of the first physical resource block pairs and a set conversion factor; and receives service data from the base station by adopting the selected TBS. In this way, a selection of the TBS by the user equipment is implemented, so that an expected coding rate can be achieved when the user equipment receives the service data transmitted by the base station according to the selected TBS, and system throughput is improved.

Further, the processor 42 may be further configured to select, according to a system configuration parameter or a system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

Further, the receiver 41 may be further configured to receive a higher-layer signaling message sent by the base station, where the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

Further, the receiver 41 may be further configured to receive a downlink control message sent by the base station, where the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

Further, the transport block size table may include: a transport block size table of layer 1 data in a Long Term Evolution Release 8 LTE REL.8 system, and the transport block size table of layer 1 data in the LTE REL.8 may be shown in Table 1. Reference may be made to Table 1, and details are not described herein again.

Further, the set conversion factor may include a first set conversion factor corresponding to a first modulation and coding scheme level and a second set conversion factor corresponding to a second modulation and coding scheme level in the transport block size table, and the first set conversion factor is different from the second set conversion factor.

Further, the first modulation and coding scheme level is a maximum modulation and coding scheme level in the transport block size table; and the second modulation and coding scheme level is a non-maximum modulation and coding scheme level in the transport block size table.

Further, the first set conversion factor is 1.1; and the second set conversion factor is 1.3.

Further, the processor 42 may be further configured to, when the number of the second physical resource block pairs is larger than the maximum number of physical resource block pairs of the transport block size table, determine that the TBS corresponding to the modulation and coding scheme level and corresponding to the number of the second physical resource block pairs is the TBS corresponding to the modulation and coding scheme level and corresponding to the maximum number of the physical resource block pairs.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A data transmission method, comprising:
determining, by a base station, a modulation and coding scheme level;
determining, by the base station, a time-frequency resource, and determining the number of first physical resource block pairs according to the time-frequency resource;
selecting, by the base station and from a transport block size table, a transport block size TBS corresponding to the modulation and coding scheme level and corresponding to the number of the first physical resource block pairs or the number of second physical resource block pairs, wherein the number of the second physical resource block pairs is a product of the number of the first physical resource block pairs and a set conversion factor;
sending, by the base station, service data to a user equipment by adopting the selected TBS; and
sending, by the base station, a system scheduling control signal to the user equipment, wherein the system scheduling control signal comprises the modulation and coding scheme level and the time-frequency resource.

2. The method according to claim 1, wherein the selecting, by the base station and from a transport block size table, a transport block size TBS corresponding to the modulation and coding scheme level and corresponding to the number of the first physical resource block pairs or the number of second physical resource block pairs, comprises:
selecting, by the base station according to a system configuration parameter or a system overhead size, the TBS corresponding to the modulation and coding scheme level and corresponding to the number of the first physical resource block pairs, or, selecting the TBS corresponding to the modulation and coding scheme level and corresponding to the number of the second physical resource block pairs.

3. The method according to claim 1, further comprising:
sending, by the base station, a higher-layer signaling message to the user equipment, wherein the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

4. The method according to claim 1, further comprising:
sending, by the base station, a downlink control message to the user equipment, wherein the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

5. The method according to claim 1, wherein the set conversion factor comprises a first set conversion factor corresponding to a first modulation and coding scheme level and a second set conversion factor corresponding to a second modulation and coding scheme level in the transport block size table, and the first set conversion factor is different from the second set conversion factor.

6. The method according to claim 5, wherein the first modulation and coding scheme level is a maximum modulation and coding scheme level in the transport block size table; and the second modulation and coding scheme level is a non-maximum modulation and coding scheme level in the transport block size table.

7. The method according to claim 1, wherein if the number of the second physical resource block pairs is larger than the maximum number of physical resource block pairs of the transport block size table, the TBS corresponding to the modulation and coding scheme level and corresponding to the number of the second physical resource block pairs is a TBS corresponding to the modulation and coding scheme level and corresponding to the maximum number of the physical resource block pairs.

8. A data transmission method, comprising:
receiving, by a user equipment, a system scheduling control signal sent by a base station, wherein the system scheduling control signal comprises a modulation and coding scheme level and a time-frequency resource;
selecting, by the user equipment and from a transport block size table, a transport block size TBS corresponding to the modulation and coding scheme level and corresponding to the number of the first physical resource block pairs or the number of second physical resource block pairs, wherein the number of the second physical resource block pairs is a product of the number of the first physical resource block pairs and a set conversion factor; and
receiving, by the user equipment, service data from the base station by adopting the selected TBS.

9. The method according to claim 8, wherein the selecting, by the user equipment and from a transport block size table, a transport block size TBS corresponding to the modulation and coding scheme level and corresponding to the number of the first physical resource block pairs or the number of second physical resource block pairs, comprises:
selecting, by the user equipment according to a system configuration parameter or a system overhead size, the TBS corresponding to the modulation and coding scheme level and corresponding to the number of the first physical resource block pairs, or, selecting the TBS corresponding to the modulation and coding scheme level and corresponding to the number of the second physical resource block pairs.

10. The method according to claim 8, further comprising:
receiving, by the user equipment, a higher-layer signaling message sent by the base station, wherein the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

11. The method according to claim 8, further comprising:
receiving, by the user equipment, a downlink control message sent by the base station, wherein the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

12. The method according to claim 8, wherein the set conversion factor comprises a first set conversion factor corresponding to a first modulation and coding scheme level and a second set conversion factor corresponding to a second modulation and coding scheme level in the transport block size table, and the first set conversion factor is different from the second set conversion factor.

13. The method according to claim 12, wherein the first modulation and coding scheme level is a maximum modulation and coding scheme level in the transport block size table; and the second modulation and coding scheme level is a non-maximum modulation and coding scheme level in the transport block size table.

14. The method according to claim 8, wherein if the number of the second physical resource block pairs is larger than the maximum number of physical resource block pairs of the transport block size table, the TBS corresponding to the modulation and coding scheme level and corresponding to the number of the second physical resource block pairs is a TBS corresponding to the modulation and coding scheme level and corresponding to the maximum number of the physical resource block pairs.

15. A base station, comprising:
a processor, configured to determine a modulation and coding scheme level; determine a time-frequency resource, and determine the number of first physical resource block pairs according to the time-frequency resource; and select, from a transport block size table, a transport block size TBS corresponding to the modulation and coding scheme level and corresponding to the number of the first physical resource block pairs or the number of second physical resource block pairs, wherein the number of the second physical resource block pairs is a product of the number of the first physical resource block pairs and a set conversion factor; and
a transmitter, configured to send service data to a user equipment by adopting the selected TBS; and send a system scheduling control signal to the user equipment, wherein the system scheduling control signal comprises the modulation and coding scheme level and the time-frequency resource.

16. The base station according to claim 15, wherein the processor is further configured to select, according to a system configuration parameter or a system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

17. The base station according to claim 15, wherein the transmitter is further configured to send a higher-layer signaling message to the user equipment, wherein the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

18. The base station according to claim 15, wherein the transmitter is further configured to send a downlink control message to the user equipment, wherein the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

19. The base station according to claim 15, wherein the set conversion factor comprises a first set conversion factor corresponding to a first modulation and coding scheme level and a second set conversion factor corresponding to a second modulation and coding scheme level in the transport block size table, and the first set conversion factor is different from the second set conversion factor.

20. The base station according to claim 19, wherein the first modulation and coding scheme level is a maximum modulation and coding scheme level in the transport block size table; and the second modulation and coding scheme level is a non-maximum modulation and coding scheme level in the transport block size table.

21. The base station according to a claim 15, wherein the processor is further configured to determine, when the number of the second physical resource block pairs is larger than the maximum number of physical resource block pairs of the transport block size table, that the TBS corresponding to the modulation and coding scheme level and corresponding to the number of the second physical resource block pairs is a TBS corresponding to the modulation and coding scheme level and corresponding to the maximum number of the physical resource block pairs.

22. A user equipment, comprising:
a receiver, configured to receive a system scheduling control signal sent by a base station, wherein the system scheduling control signal comprises a modulation and coding scheme level and a time-frequency resource; and
a processor, configured to select, from a transport block size table, a transport block size TBS corresponding to the modulation and coding scheme level and corresponding to the number of the first physical resource block pairs or corresponding to the number of second physical resource block pairs, wherein the number of the second physical resource block pairs is a product of the number of the first physical resource block pairs and a set conversion factor; and receive service data from the base station by adopting the selected TBS.

23. The user equipment according to claim 22, wherein the processor is further configured to select, according to a system configuration parameter or a system overhead size, the TBS corresponding to the modulation and coding scheme level and corresponding to the number of the first physical resource block pairs, or, select the TBS corresponding to the modulation and coding scheme level and corresponding to the number of the second physical resource block pairs.

24. The user equipment according to claim 22, wherein the receiver is further configured to receive a higher-layer signaling message sent by the base station, wherein the higher-layer signaling message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

25. The user equipment according to claim 22, wherein the receiver is further configured to receive a downlink control message sent by the base station, wherein the downlink control message carries instruction information of selecting the TBS corresponding to the modulation and coding scheme level and corresponding to the number of the first physical resource block pairs, or, of selecting the TBS corresponding to the modulation and coding scheme level and corresponding to the number of the second physical resource block pairs.

26. The user equipment according to claim 22, wherein the set conversion factor comprises a first set conversion factor corresponding to a first modulation and coding scheme level and a second set conversion factor corresponding to a second modulation and coding scheme level in the transport block size table, and the first set conversion factor is different from the second set conversion factor.

27. The user equipment according to claim 26, wherein the first modulation and coding scheme level is a maximum modulation and coding scheme level in the transport block size table; and the second modulation and coding scheme level is a non-maximum modulation and coding scheme level in the transport block size table.

28. The user equipment according to claim 22, wherein the processor is further configured to determine, when the number of the second physical resource block pairs is larger than the maximum number of physical resource block pairs of the transport block size table, that the TBS corresponding to the modulation and coding scheme level and corresponding to the number of the second physical resource block pairs is a TBS corresponding to the modulation and coding scheme level and corresponding to the maximum number of the physical resource block pairs.
